(19) United States
(12) Patent Application Publication
(10) Pub. No.: US 2026/0285414 A1
(43) Pub. Date: Sep. 24, 2026

(54) Cross-member, which is composed of at least two components, for a vehicle

(71) Applicant: Kirchhoff Automotive Deutschland GmbH, Attendorn (DE)

(72) Inventors: Alexander Günther, Olpe (DE); Aydogan Gündogan, Plettenberg (DE); Dominik Tentscher, Hemer (DE)

(21) Appl. No.: 19/471,964

(22) PCT Filed: Mar. 27, 2024
(86) PCT No.: PCT/EP2024/058333

§ 371 Date: Oct. 2, 2025

(30) Foreign Application Priority Data
Apr. 3, 2023 (DE) 10 2023 108 497.6

(51) Int. Cl. B62D 25/14; B62D 27/06

(52) U.S. Cl. CPC B62D 25/145; B62D 27/065

(57) ABSTRACT

A cross-member for a vehicle, in particular a motor vehicle, composed of at least two components connected together in a force-fitting manner in order to form the cross-member. The two respective cross-member components are arranged so as to have an overlap with each other and are connected together by at least one fastener which is arranged in the overlap, passes through the two cross-member components or parts thereof, and clamps the two cross-member components together such that the force fit between the two cross-member components results from the pre-tensioning force provided by the at least one fastener. The fastener opening, through which a fastener passes, of one of the two cross-member components is designed with a movement clearance so that when a force acting on the cross-member is exceeded which is greater than the clamping force between the two cross-member components, said clamping force being applied by the pretension of the at least one fastener, the two cross-member components are adjusted relative to each other in the dimension allowed by the movement clearance.

### BACKGROUND

The disclosure relates to a cross-member for a vehicle, which is composed of at least two components, each having a connecting part at the end, which cross-member components extend in the longitudinal direction of the cross-member and are connected to one another in a friction-locked manner to form the cross-member.

Such cross-members are dashboard supports, for example. Dashboard supports are used to mount instruments and the steering column in a vehicle. Such a dashboard support is installed between two pillars, namely the A-pillars of a motor vehicle. To connect to the A-pillars, the dashboard support has corresponding mechanical connectors at both ends. An essential component of such a dashboard support is a support structure. This extends between the pillars of the body of the vehicle. The support structure can be provided with connections for instruments as well as other fixing points relative to the vehicle, such as floor supports by which the support structure is supported using the floor of the vehicle, for example in the area of a tunnel.

A dashboard support can, but does not have to, be straight. Often such a dashboard support is structured so that parts of it extend offset from one another with respect to their longitudinal extension. The support parts are typically tubular bodies, which can also be composed of two or more shells or shell parts. In addition to dashboard supports, which are made from a continuous support tube body, ones are also used in which several support parts which follow the longitudinal extension are provided. Depending on the design of the desired dashboard support, these are arranged axially aligned with one another or offset from one another with respect to their longitudinal extension. In the first case, a connecting sleeve is usually used to connect the two support parts. In an offset arrangement, a support part connector, in many cases a metal connector, is used to connect the two support parts. This connector bridges the gap due to the offset between two adjacent support parts. Such dashboard supports can, for example, have a section in the middle that is set back from the two outer support parts in order to create space for the installation of a unit of the vehicle, for example the climate control system. The support structure is then guided around this unit.

The individual components of such a cross-member are welded to one another in a friction-locked manner in order to meet the requirements placed thereon. Such a cross-member composed of a plurality of cross-member components, the cross-member components of which are connected to one another by material bonding in order to achieve the desired frictional connection, is known, for example, from DE 10 2018 126 040 A1.

Against the background of increasing requirements for occupant protection, such cross-members, in particular if designed as dashboard supports, are designed to be increasingly stable, above all in order to be able to withstand higher forces in the event of a frontal crash. For this purpose, more and more cross-member supports are also increasingly used, i.e. supports via which the dashboard support is supported on the body side in addition to its connection to the A-pillars, for example via tunnel struts, struts to the body floor or to the cowl. The attempt to adapt such cross-members designed as dashboard supports to increased requirements is accompanied by an increase in weight.

### SUMMARY

Against this background, one aspect of the disclosure is to propose a cross-member for a vehicle, in particular as a dashboard support, which can withstand even higher loads in a frontal crash load case without having to accept failure, for example, in the area of the connection of the cross-member to the body or within the cross-member.

This is achieved according to the disclosure by a cross-member of the type mentioned at the outset, wherein two cross-member components are arranged with an overlap to one another and are connected to one another by at least one fastener that is arranged in the overlap, passes through the two cross-member components or parts thereof, and clamps them together in such a way that the frictional connection between the two cross-member components results from the pretensioning force provided by the at least one fastener, and wherein the fastener opening of at least one of the two cross-member components passed through by a fastener is designed with a movement play so that when a force acting on the cross-member is exceeded which is higher than the clamping force between the two cross-member components applied by the pretensioning of the at least one fastener, the two cross-member components are adjusted relative to one another to the extent permitted by the movement play.

In contrast to previously known vehicle cross-members, this cross-member implements a completely different concept. In this cross-member, two cross-member components, which are arranged with an overlap to one another, are adjustable in relation to one another in the event of a strain, for example in the event of a frontal crash load case when a certain force is exceeded. Such an overlapping section of two cross-member components thus acts in the manner of a force-absorbing crash element which can be subjected to strain. This cross-member is designed with regard to the frictional connection of its at least two cross-member components, so that the frictional connection meets the intended requirements. Only when a certain force is exceeded, namely the clamping force provided by the at least one fastener, can the two cross-member components arranged in overlap with one another be adjusted relative to one another. The intended frictional connection is provided by the clamping force which is provided as a result of the pre-load acting due to the fastener(s). The clamping force is the force with which the two cross-member components are pressed together in the area of their overlap. In order to permit the desired movement of the two cross-member components connected in this way, at least one of the two interacting fastener openings is designed with a movement play. This means that the cross-sectional area of such a fastener opening is larger by the required or desired movement play than the shaft of the fastener passing through this fastener opening. Such a fastener opening having the required movement play can have a circular circumference, for example. If the fastener is installed in the center of this fastener opening, the two cross-member components connected to one another in this overlap can basically be adjusted in relation to one another in any direction. Typically, however, the outline shape of such a fastener opening will be designed in such a way that the two cross-member components are adjusted in a preferred direction. In this case, such a fastener opening, which has the movement play, is typically designed in the manner of an elongated hole. In many cases, the cross-member components arranged in the overlap are only adjustable relative to one another in a direction-limited manner anyway as a result of their overlap. In the case of this cross-member, the permitted movement play between the two cross-member components is typically designed in such a way that it can be absorbed by an elongation of the cross-member before a break occurs when higher forces are applied. For this reason, such a cross-member can be designed without any problems with regard to the deformation path to be absorbed in the event of a crash by corresponding dimensioning of the movement play so that it meets the test requirements set thereon. In the event of a front crash load case, the relevant force acts on the area in the middle of a cross-member designed as a dashboard support, so that it tends to deform in the direction of the vehicle interior. This is possible in the cross-member according to the disclosure at least within the scope of the possible movement play, as a result of which other fixing points, for example the connection of the cross-member to the A-pillars of the vehicle body, are relieved and do not fail even with only a small deformation travel absorption. Failure of a connection in the area in question entails the risk that the ends of the cross-member parts will then be deformed into the interior of the vehicle, which in turn represents an increased risk of injury to the occupants.

The frictional connection between its at least two cross-member components required for an intended use of the cross-member can be set by means of the pre-load using which the fastener(s) of the two cross-member components arranged in overlap with one another are clamped. Further measures can support such a connection in order to increase the friction of the two cross-member components clamped by at least one fastener. The frictional connection can also be set at the desired level by the number of fasteners used in the overlap of two cross-member components. The use of multiple fasteners is preferred because this allows a more individual adjustment of the frictional connection, preferably on the side of such a cross-member facing toward the vehicle interior and on its opposite outer side.

In the case of such a cross-member, it is also advantageous that by connecting two cross-member components by means of at least one, but preferably by means of multiple fasteners, in particular screw fasteners, cross-member components made of different materials can be connected to one another without problems. In contrast to materially-bonded connections, such a connection, should this be necessary, is also detachable.

As a result of the relief of the connection points of the cross-member to the body of the vehicle, these can be designed to be more slender. In addition, the cross-member can be dimensioned better due to this deformation behavior and does not require over-dimensioning in partial areas.

In order to facilitate the assembly of two cross-member components to be fastened to one another in the area of their overlap, it is provided in an example embodiment, in which multiple screw fasteners are used for connecting and clamping two cross-member components in the region of their overlap with one another, that one of the two cross-member components is already equipped with nuts. These can be weld nuts, punch nuts, or rivet nuts, for example. This list is not exhaustive. Such a design is particularly useful when two hollow chamber profiles are to be connected to one another as cross-member components, wherein one cross-member component engages with an end section into the open end of the other cross-member component. In such a case, the nuts are assigned to the cross-member component located on the inside in the overlap, specifically on their inner side. During assembly, the two cross-member components only have to be configured with respect to their position relative to one another. The screw fasteners are then screwed into the internal threads provided by the nuts. The fastener openings of the cross-member component located on the outside with respect to the overlap are designed having the required movement play.

The movement play typically extends in the direction of the longitudinal extension of the cross-member.

Nuts which can also be used for such a fastening are those using which the two mutually facing surfaces of two cross-member components are kept at a distance from one another in the overlapping area. In such a design, one section of a nut passes through the fastener perforation of the cross-member component on the inside in the overlap and protrudes in relation to the outer side facing toward the other cross-member component. In such a design, the cross-member component on the outside in the overlap is then supported on the end face of such a nut. This achieves a concentration of force, so that due to such a measure and also the dimensioning of the area of the front face, the level of the force connection can be configured, up to which a relative movement of the two cross-member components does not occur. Pressing this end face to a certain extent into the wall of the cross-member component facing toward it can also be used as a measure to configure the frictional connection or the release force required to displace the two cross-member components. In order to enlarge such a contact surface, it can be provided that such a surface is flattened from the fastener opening of the cross-member component located inside the overlap to form a collar which extends over the edge of the relevant fastener opening. It is advantageous if such a nut also has a collar on the inside, since then, due to the formation of the outer collar, this nut is at the same time connected to this cross-member component in a form-fitting manner. Other means for spacing apart two cross-member components to be connected in overlap to one another are also possible.

Depending on the position of the two cross-member components arranged overlapping one another within the cross-member, the movement play can be designed differently, i.e. directed in a certain direction, for example, or can be designed having a different dimension. In this way, the deformation behavior of the cross-member can be influenced.

Such a cross-member may well have more than two cross-member components which are connected to one another in the above-described manner. Such a cross-member then has multiple points that allow the cross-member to elongate (stretch) in case of a frontal crash.

Typically, such a cross-member will be designed to comprise at least two cross-member components extending in the longitudinal direction of the cross-member. If such a cross-member is composed of two such cross-member components with respect to its longitudinal extension, the overlap is preferably located in a middle section of the cross-member. Certainly, the connection of two such cross-member components will be placed where a corresponding installation space is available. Sometimes two cross-member components extending in the longitudinal extension of the cross-member are also arranged with spacing from one another. These are then connected to a connecting component which is typically cranked in order to provide space for accommodating a unit in the area of the middle of the vehicle with respect to its transverse extension. It is also entirely possible for two such cross-member components to be connected to one another by the housing of a unit itself. These two cross-member components can be connected to such a unit or to a connector component in the same way as described above with reference to two cross-member components. The unit or the connector component then represents a cross-member component in the sense of these designs.

Instead of such a connecting piece, two cross-member components arranged at a small distance from one another or even abutting one another can be connected to one another by a third cross-member component as a connector. This third component is arranged in the overlap with the other two cross-member components and is connected thereto in the above-described manner. Such a third cross-member component can be, for example, the connection of a tunnel support or also any other support of the cross-member.

It is also entirely possible to design the cross-member having connecting parts for connecting the cross-member to the vehicle body, for example the A-pillars, in such a way that these are connected to the cross-member or a cross-member component in the same way as a cross-member component in the sense of these designs.

### BRIEF DESCRIPTION OF THE DRAWINGS

The following description is provided on the basis of example embodiments with reference to the appended drawings, where:

FIG. 1 shows a perspective view of a schematically shown cross-member designed as a dashboard support according to a first embodiment,

FIG. 2 shows a front view of the cross-member of FIG. 1 without screw fasteners,

FIG. 3 shows an enlarged detailed representation from the area of the cross-member of FIG. 2 indicated in FIG. 2,

FIG. 4 shows a cross-sectional view through the cross-member of FIG. 2 along line A-B,

FIG. 5 shows a detailed enlargement of the cross section of FIG. 4,

FIG. 6 shows a top view of the cross-member of the preceding figures after a front crash load case,

FIG. 7 shows a detailed enlargement of the deformed cross-member of FIG. 6 in a front view, shown without screw fasteners,

FIG. 8 shows a force-displacement diagram to illustrate the deformation behavior of the cross-member of the preceding figures in comparison to a cross-member according to the prior art,

FIG. 9 shows another example embodiment of a cross-member according to the disclosure in a perspective view,

FIG. 10 shows another example embodiment of a cross-member according to the disclosure, and

FIG. 11 shows another example embodiment of a cross-member according to the disclosure.

### DETAILED DESCRIPTION

A cross-member 1 for a motor vehicle, designed as a dashboard support, comprises two cross-member components 2, 3. The cross-member components are designed as hollow chamber profiles in the example embodiment shown. The cross-member components 2, 3 designed as hollow chamber profiles have been brought into the shape shown in the figures from steel plates in the example embodiment shown. At the ends pointing away from one another, the two cross-member components 2, 3 each bear a connecting part 4 and 5, not specified in more detail, for connecting the cross-member 1 to the A-pillars of a vehicle, between which the cross-member 1 extends.

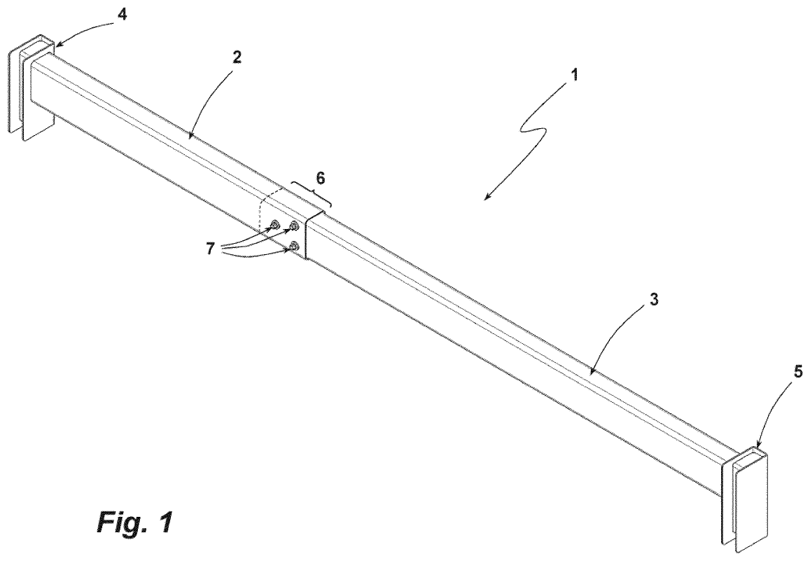

The two cross-member components 2, 3 are designed with respect to their cross-sectional geometry such that the cross-member component 3 can be inserted with its one end section into the open end of the cross-member component 2. The width of the engagement of the cross-member component 3 in the cross-member component 2 is indicated by dashed lines in FIG. 1. This area is also referred to as an overlap 6 in the context of these designs. In the area of the overlap 6, the two cross-member components 2, 3 are connected to one another using multiple screw fasteners 7 and clamped against one another. In the example embodiment shown, three screw fasteners are mounted on the front side and three further screw fasteners are mounted on the opposite rear side of the cross-member 1. The screw fasteners 7 do not pass through the cross-member components 2, 3 as a whole, but only the walls thereof arranged adjacent to one another. For the purpose of assembling the two cross-member components 2, 3 with one another, the walls of the two cross-member components 2, 3 arranged adjacent to one another-in this case the respective front wall and the respective rear wall-are clamped with one another. For this purpose, both cross-member components 2, 3 have fastener openings 8, 9 which are aligned with one another in their overlap.

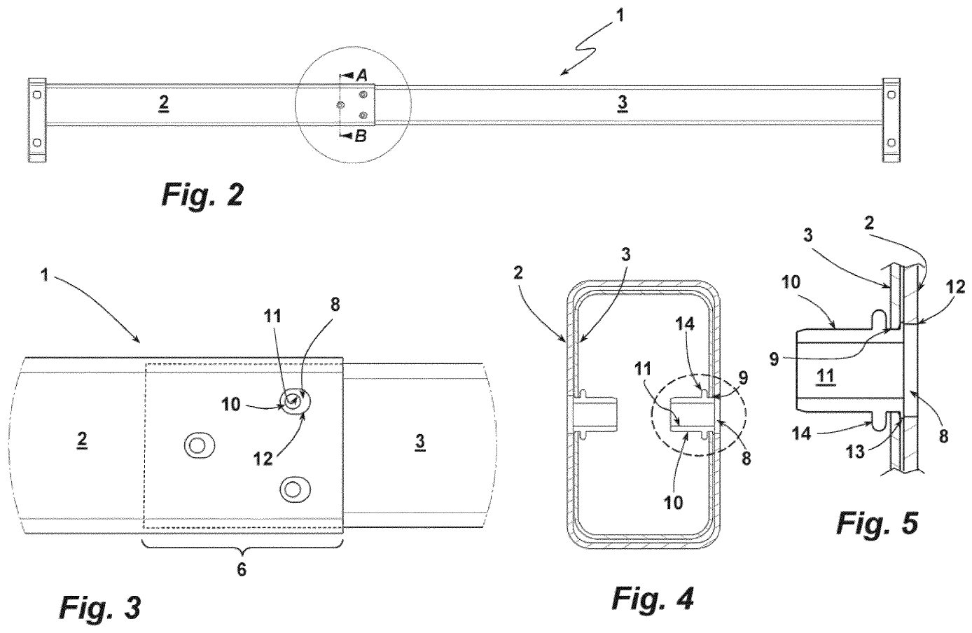

A special feature of the cross-member 1 is that the fastener openings 8, 9 are designed differently with regard to their width and cross-sectional area. As can be seen from FIG. 4, a nut 10 is inserted into the fastener opening 9. A screw fastener 7 engages with its screw shaft in its internal thread 11. In the front view of the cross-member 1 in FIGS. 2 and 3, it is shown without the screw fasteners 7 screwed into the nuts 10. Above all, the detailed enlargement of FIG. 3 from the area of the overlap 6 clearly shows that the fastener openings 8 of the cross-member component 2 are significantly larger than those of the inner cross-member component 3. The location and diameter of the screw shaft of the screw fasteners within the fastener opening 8 can be recognized from the internal thread 11 of the nuts 10. The screw shaft is arranged within the fastener opening 8 with movement play. This is the remaining space between the lateral surface of the screw shaft of a screw fastener 7 passing through the fastener opening 8 and the edge 12 of the fastener opening 8. The fastener opening 8 is designed in the manner of an elongated hole, the axis of which points in the direction of the longitudinal extension of the cross-member 1. This permits a movement play in which the two cross-member components 2, 3 connected to one another in the overlap 6 can be moved away from one another in the direction of the longitudinal extension of the cross-member 1 when a corresponding force acting in this direction is applied.

In the illustrated example embodiments, the nuts 10 are designed so that a section of them protrudes out of the fastener opening 9, as shown in FIGS. 4 and 5. The section of the nut 10 projecting in relation to the flat side of this wall of the cross-member component 3 is formed into a collar 13 which projects beyond the edge of the fastener opening 8. The collar 13 is thus used as a spacer to the adjacent wall of the cross-member component 2. Due to the spacing of the two walls of the cross-member components 2, 3 arranged adjacent to one another in the overlap 6, these can therefore also be produced without problems from different materials, without contact corrosion having to be accepted. As is clear from the sectional view of FIG. 4, the outer lateral surface of the cross-member component 3 located on the inside in the overlap 6 is circumferentially spaced apart from the inner side of the outer cross-member component 2.

The nuts 10 also have a collar 14 projecting in the radial direction beyond the fastener opening 9 on the inside. In this way, they are held in a form-fitting manner on the wall of the cross-member component 3.

If the two cross-member components 2, 3 are clamped together by the screw fasteners engaging in the nuts 10, typically with a predefined clamping force, the clamping force generated thereby is sufficiently high to meet the requirements for a frictional connection between the two cross-member components 2, 3 when the cross-member 1 is used as intended.

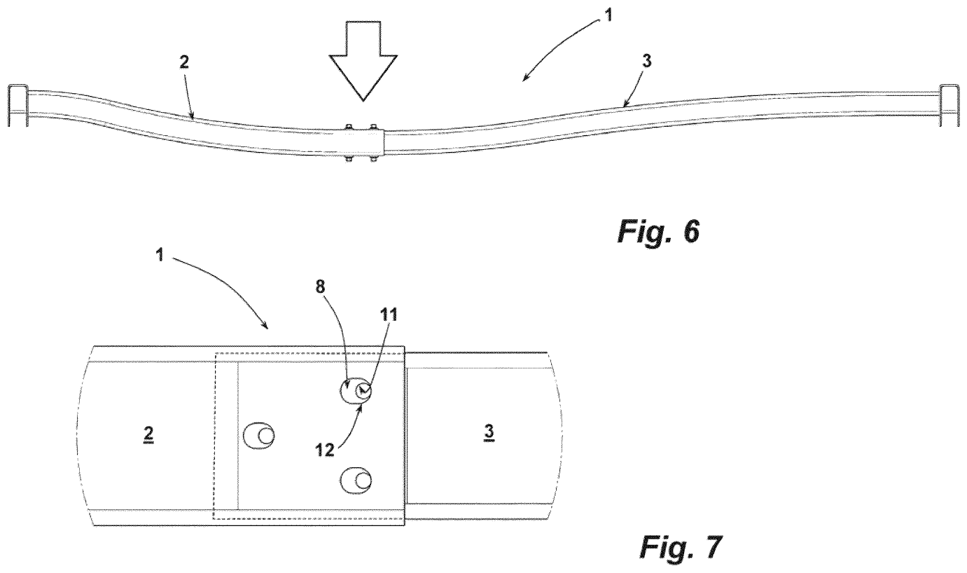

In case of a front crash which exceeds the clamping connection between the two cross-member components 2, 3 in the area of the overlap 6, the cross-member 1, as shown in FIG. 6, will deform in an S-shape in the direction toward the interior of the vehicle. Such a deformation is possible by the above-described connection of the two cross-member components 2, 3, since an elongation (stretch) of the cross-member 1 is possible due to the remaining movement play. The force acting on the cross-member 1 in such a case is thus first converted into a deformation of the cross-member 1, accompanied by a force absorption for adjusting the two cross-member components 2, 3 relative to one another. This leads to the result that the connecting parts 4, 5 or the connection of the cross-member 1 to the A-pillars of the vehicle body caused thereby are loaded significantly less. The risk of one of these connection points breaking is correspondingly lower. In such a case, the cross-member 1 can absorb correspondingly more force without endangering occupants located in the interior of the vehicle. Due to the displacement of the two cross-member components 2, 3 relative to one another, this measure provides or absorbs a certain deformation path before a further deformation occurs.

FIG. 7 shows a detailed enlargement of the front view of the cross-member 1 corresponding to the representation of FIG. 3, wherein, since the screw fasteners 7 are not shown, the change in the position of the internal threads 11 of the nuts 10 makes it clear how far the two cross-member components 2, 3 have been moved relative to one another. The dimension of this movement is the dimension of the permitted elongation or stretching of the cross-member 1 in such a case.

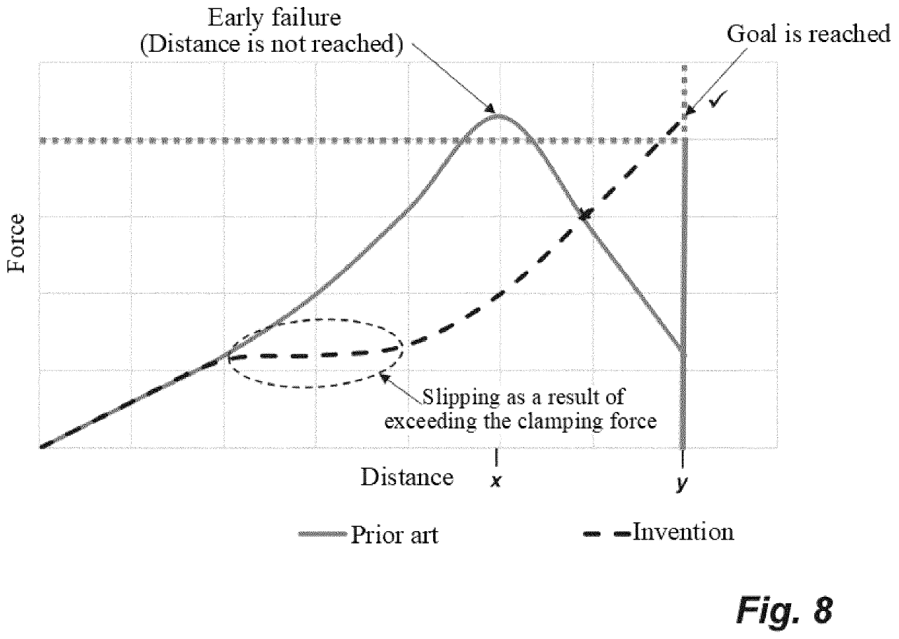

The improved behavior of the cross-member 1 in a frontal crash load case is clear from the diagram in FIG. 8. While a cross-member of a conventional type already fails after a deformation path x, since at least one connection point is torn off and thus no further forces can be absorbed, in the case of a cross-member of the same design according to the disclosure, but with the above-described movement play, it was still possible to absorb forces even when the required deformation path has been reached. Therefore, failure could not be detected up to the deformation distance y required to pass a deformation test.

This better behavior is determined by the fact that the cross-member 1 may experience a certain elongation in the overlap 6 of its cross-member components 2, 3 and that, as a result of the applied clamping force, the two cross-member components 2, 3 can only be adjusted relative to one another with force. In the diagram of FIG. 8, this section in the curve is marked as slipping due to exceeding the clamping force. The fact that the force required for adjustment does not diminish can be clearly seen from the curve profile of this section. Due to the possibility of displacing the two cross-member components 2, 3 to cause elongation of the cross-member 1, further deformation is only introduced into the cross-member 1 when the movement play is exhausted, i.e. the screw shaft of the screw fasteners 7 has reached the edge 12 of the fastener opening 8, as shown in FIG. 7. Thus, the movement play represents part of the required deformation path in which the two cross-member components 2, 3 can be adjusted in relation to one another without damage.

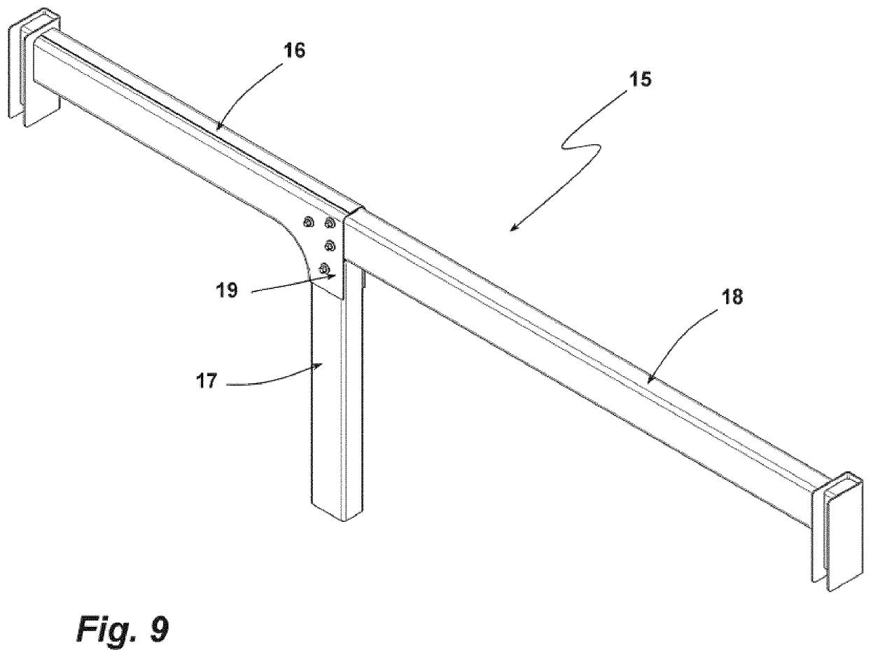

In the example embodiment of the preceding figures, the cross-member 1 is composed of two cross-member components 2, 3 following the longitudinal extension of the cross-member 1. This also applies in principle to the cross-member 15 shown in FIG. 9. The cross-member 15 differs from the cross-member 1 in that the cross-member component 16 seated on the outside in the area of the overlap is formed so that a support 17, for example in the form of a tunnel support, can be connected thereto. The cross-member component 16 is connected to the cross-member component 18 which engages in its open end section and which is the same as the cross-member component 2 of the above-mentioned example embodiment. In the same way, the support 17 is connected to the cross-member component 16, wherein the support 17 is also connected using its upper end section with an overlap to the connecting section 19 pointing towards the support 17.

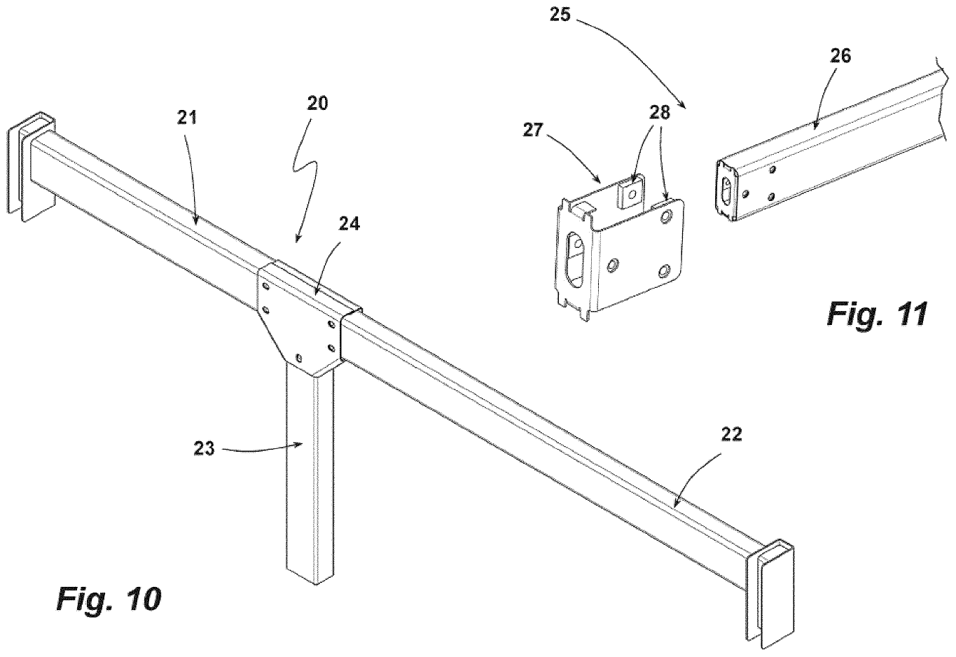

FIG. 10 shows another example embodiment of a cross-member according to the disclosure. This cross-member 20 has two cross-member components 21, 22 which follow the longitudinal extension of the cross-member 20. Furthermore, the cross-member 20 has a support 23. These three cross-member components 21, 22, 23 are connected via a connecting element 24 which represents a further cross-member component. The cross-member components 21, 22, 23 are connected to the connecting element 24, as described for the example embodiment of FIGS. 1 to 7 between the two cross-member components 2, 3. The cross-member 20 makes it clear that the concept according to the disclosure can also be implemented in so-called “nodes”.

The concept according to the disclosure can also be implemented at the connecting parts using which the cross-member is connected to the vehicle body, typically the A-pillar of a vehicle. FIG. 11 shows such an example. This cross-member 25 has a cross-member component 26 which extends in the longitudinal extension of the cross-member 25. The end-side connecting part 27 is shown in the manner of an exploded view spaced apart from the end of the cross-member component 26. The connecting part 27 is U-shaped in a top view and its legs overlap the end section of the cross-member component 26. The cross-member component 26 and the connecting part 27 are connected in the same way as described above with reference to the other example embodiments. In contrast to the nuts 10 of the preceding example embodiments, the connecting part 27 bears weld nuts 28 at the corresponding positions.

### LIST OF REFERENCE NUMERALS

1 cross-member
2 cross-member component
3 cross-member component
4 connecting part
5 connecting part
6 overlap
7 screw fastener
8 fastener opening
9 fastener opening
10 nut
11 internal thread
12 edge
13 collar
14 collar
15 cross-member
16 cross-member component
17 support
18 cross-member component
19 connection section
20 cross-member
21 cross-member component
22 cross-member component
23 support
24 connecting element

1-18. (canceled)

19. A cross-member for a vehicle comprising:
at least two cross-member components which extend in a longitudinal extension of the cross-member and are frictionally connected to one another,
wherein the two cross-member components are arranged with an overlap in relation to one another and are connected to one another by at least one fastener which is arranged in the overlap and passes through the two cross-member components or parts thereof,
wherein the frictional connection between the two cross-member components results from a pre-tensioning force provided by the at least one fastener, and
wherein a fastener opening of at least one of the two cross-member components passed through by the fastener is configured with a movement play to allow an elongation of the cross-member in event of a frontal impact, such that when a force acting on the cross-member in event of a frontal impact is exceeded, which force is higher than a clamping force set by pre-tensioning of the at least one fastener between the two cross-member components, the two cross-member components are adjustable relative to one another to the extent permitted by the movement play.

20. The cross-member of claim 19, wherein the at least one fastener is a screw fastener.

21. The cross-member of claim 20, wherein multiple screw fasteners for connecting the two cross-member components are provided in the region of the overlap thereof, wherein one of the two cross-member components is equipped with nuts on a side thereof facing away from the other cross-member component, wherein each screw fastener engages an internal thread of a respective nut, and wherein the fastener opening of the other cross-member component is configured to provide the movement play.

22. The cross-member of claim 21, wherein a section of the nuts of the one cross-member component reach through the respective fastener opening assigned thereto and project out of the fastener opening in a direction of the other cross-member component.

23. The cross-member of claim 22, wherein the section of the nut projecting out of the fastener opening is formed into a collar which engages over an edge of the fastener opening in a radial direction.

24. The cross-member of claim 21, wherein the movement play of at least one fastener opening for the screw fastener passing therethrough is different than in another fastener opening.

25. The cross-member of claim 19, wherein the movement play of the at least one fastener opening permits freedom of movement of the fastener passing therethrough in multiple directions.

26. The cross-member of claim 19, wherein the movement play of the at least one fastener opening permits freedom of movement of the fastener passing therethrough in a preferred direction.

27. The cross-member of claim 26, wherein the at least one fastener opening is formed as an elongated hole.

28. The cross-member of claim 19, wherein the cross-member comprises at least two cross-member components extending in the transverse direction thereof and arranged with overlap in relation to one another.

29. The cross-member of claim 28, wherein the overlap of the two cross-member components (is arranged in a middle section of the cross-member with respect to the longitudinal extension thereof.

30. The cross-member of claim 28, wherein the cross-member components are at least partially formed as hollow profiles, and fasteners are provided in the overlap both on a side facing forward in a direction of travel and on a side opposite thereto to connect the two cross-member components.

31. The cross-member of claim 28, wherein the overlap of the cross-member components is provided in the area of a support structure connected thereto.

32. The cross-member of claim 31, wherein the support structure is a tunnel support.

33. The cross-member of claim 19, wherein two cross-member components extending in the longitudinal extension of the cross-member are connected to one another by a third cross-member component arranged with the overlap in relation to the two cross-member components.

34. The cross-member of claim 19, wherein ends of the cross-member are equipped with a respective connecting part for connecting the cross-member to a vehicle body as a cross-member component having an overlap in relation to an adjacent cross-member component.

35. The cross-member of claim 19, wherein the cross-member is a dashboard support.

36. A use of an overlap arrangement provided from at least two cross-member components of a cross-member for a vehicle according to claim 19, wherein when the force acting on the cross-member in event of a frontal impact is exceeded, which force is higher than the clamping force set by pre-tensioning of the at least one fastener between the two cross-member components, the overlap acts as a force-absorbing crash element loadable by stretching, and in case of such a force absorption, the two cross-member components are adjusted relative to one another to the extent permitted by the movement play.
